(19) United States
(12) Patent Application Publication
(10) Pub. No.: US 2016/0197375 A1
(43) Pub. Date: Jul. 7, 2016

(54) GEL ELECTROLYTE COMPOSITION FOR RECHARGEABLE BATTERIES

(71) Applicant: EMPIRE TECHNOLOGY DEVELOPMENT LLC, Wilmington, DE (US)

(72) Inventors: William Brenden CARLSON, Seattle, WA (US); Gregory David PHELAN, Cortland, NY (US)

(73) Assignee: EMPIRE TECHNOLOGY DEVELOPMENT LLC, Wilmington, DE (US)

(21) Appl. No.: 14/910,640

(22) PCT Filed: Aug. 5, 2013
(86) PCT No.: PCT/US13/53574

§ 371 Date: Feb. 5, 2016

(51) Int. Cl. H01M 10/0565; H01M 4/136; H01M 10/0525

(52) U.S. Cl. CPC H01M 10/0565; H01M 10/0525; H01M 4/136; H01M 2004/028

(57) ABSTRACT

Compositions and methods for making gel electrolytes for batteries are disclosed. The gel electrolyte composition may include a polymer with a plurality of isocyanate groups and a blocking agent contacting at least one of the plurality of isocyanate groups. At least one negative electrode and at least one positive electrode may be in contact with the gel electrolyte composition to form a battery.

### BACKGROUND

Lithium ion batteries are commonly used as sources for electrical current for both consumer and industrial applications. During discharge, lithium ions migrate from the higher chemical potential negative electrode to the positive electrode through the electrolyte, to produce an electrical current. During recharge, lithium ions move back to the negative electrode. The negative electrode is often made from carbon, silicon, germanium, or titanates. The positive electrode generally includes a lithium host material that stores intercalated lithium at a relatively low electrochemical potential. In addition, the lithium ion batteries usually contain a separator between the positive and negative electrode, wherein the separator is impregnated with an electrolyte solution. A lithium ion battery involving an electrolyte solution usually requires a firm casing for enclosing an electrolyte solution, to prevent leakage and impact from accidents, and to prevent fire due to short circuit. This imposes a limitation on the shape of a battery, leading to difficulty in making a battery that is thin and lightweight.

Lithium ion batteries having gel electrolyte have gathered considerable attention because of their thin size and flexibility. In such batteries, the electrolyte is in the form of a polymer gel which can conduct ions between the two electrodes. These polymer electrolytes do not leak like the conventional electrolyte solutions and allow the manufacture of batteries that are versatile in shape and size. Furthermore, the polymer electrolyte can be adhered to an electrode, a separator and/or the like, and are effective for making a battery thinner and improving battery flexibility.

However, gel electrolytes have significant drawbacks. Lithium ion batteries with gel polymer electrolytes are prone to uncontrolled discharge (runaway reaction) that can lead to production of significant heat and explosion. Further, the polymers can decompose liberating toxic materials, such as hydrofluoric acid. The organic solvents can be flammable and may pose a fire hazard. Thus, there is a need to develop rechargeable batteries with better and more efficient gel electrolytes that can overcome these problems.

### SUMMARY

The present disclosure provides compositions and methods for making gel electrolytes for rechargeable batteries. In one embodiment, a battery may include a gel electrolyte composition made of a polymer with a plurality of isocyanate groups; a blocking agent contacting at least one of the plurality of isocyanate groups; and at least one negative electrode and at least one positive electrode in contact with the gel electrolyte composition.

In an additional embodiment, a gel electrolyte composition may include a polymer having a plurality of isocyanate groups, and a blocking agent contacting at least one of the plurality of isocyanate groups.

In another embodiment, a method of preparing a gel electrolyte composition may include contacting a blocked polymer comprising a plurality of blocked isocyanate groups with a solvent, a cross-linker and an initiator to form a mixture; and heating the mixture to form the gel electrolyte composition.

In a further embodiment, a method of providing battery power to an electronic device using a rechargeable battery may include connecting the rechargeable battery as a power source to the electronic device. The rechargeable battery may include a gel electrolyte composition made of a polymer with a plurality of isocyanate groups; a blocking agent contacting at least one of the plurality of isocyanate groups; and at least one negative electrode and at least one positive electrode in contact with the gel electrolyte composition.

### BRIEF DESCRIPTION OF THE FIGURES

FIG. 1 depicts coordination of lithium ions by 2-methyl-acrylic acid 2-[(3,4-dimethyl-pyrazole-1-carbonyl)-amino]-ethyl ester according to an embodiment.

FIG. 2 depicts mass spectroscopic analysis of the monomer 2-methyl-acrylic acid 2-[(3,4-dimethyl-pyrazole-1-carbonyl)-amino]-ethyl ester coordinating sodium and potassium ions according to an embodiment.

FIG. 3 illustrates a rechargeable Li-ion battery with a gel electrolyte according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

The present disclosure provides compositions and methods for making gel electrolytes for rechargeable batteries. The polymer gel electrolytes disclosed herein help to minimize the runaway reactions that may take place in rechargeable batteries, thus greatly reducing the chance of explosions. In some embodiments, a battery may include a gel electrolyte composition made of a polymer with a plurality of isocyanate groups; a blocking agent contacting at least one of the plurality of isocyanate groups; and at least one negative electrode and at least one positive electrode in contact with the gel electrolyte composition. In some embodiments, the battery is a rechargeable battery.

In some embodiments, the polymer with isocyanate functional groups is made up of one or more monomeric units of the following: alkyl methacrylate, allyl methacrylate, thioalkyl methacrylate, vinyl benzene, 2-hydroxyethyl acrylate, acrylate, methacrylate, alkyl acrylate, allyl acrylate, 2-methyl-acrylic acid 2-(2-oxo-imidazolidin-1-yl)-ethyl ester, 2-methyl-acrylic acid 2-(2-oxo-imidazolidin-1-yl)-methyl ester, (2,2-pentamethylene-1,3-oxazolidyl-3)ethylmethacrylate, 2-[(2-methyl-1-oxo-2-propenyl)-oxy]ethyl 3-oxobutanoate, lithium 1-[2-(2-methyl-acryloyloxy)-ethoxycarbonyl]-propen-2-olate, sodium 1-[2-(2-methyl-acryloyloxy)-ethoxycarbonyl]-propen-2-olate, potassium 1-[2-(2-methyl-acryloyloxy)-ethoxycarbonyl]-propen-2-olate, or any cation coordinating 1-[2-(2-methyl-acryloyloxy)-ethoxycarbonyl]-propen-2-olate, and copolymers of any of the foregoing. Non-limiting examples also include polymers of furfuryl methacrylate, (polyethylene glycol) methyl ether methacrylate, tetrahydrofurfuryl methacrylate, 2-ethoxyethyl methacrylate, (poly-L-lactide) 2-hydroxyethyl methacrylate, 2-(2-methoxyethoxy)ethyl methacrylate, 2-methyl-acrylic acid [1,4]dioxan-2-yl ester, and copolymers of any of the foregoing. An exemplary polymer may be a polymer of isocyanatoethyl methacrylate.

In some embodiments, the blocking agent contacting the isocyanate functional groups may be an alcohol, an imidazole, a methyl imidazole, a pyrazole, a pyrrole, a pyrrolidine, a morpholine, a pyridine, a piperidine, an alkyl malonate ester, an acetoacetic ester, a cyanoacetic ester, an oxime, a caprolactam, or any combination thereof. An example of a blocking agent may be 3,4-dimethyl-1H-pyrazole.

In some embodiments, the gel electrolyte composition may further contain one or more inorganic salts having a conduction property. In some embodiments, the inorganic salts may be uniformly dispersed in the polymer described herein. Non-limiting examples include lithium salts, such as Li₂B₄O₇, Li₂ZrO₃, Li₂TiO₃, Li₄SiO₄, LiAlO₂, LiBO₂, LiAlSi2O₆, LiPF₆, LiAsF₆, LiClO₄, LiBF₄, LiCF₃SO₃, and any combination thereof. In addition, the electrolyte may also include sodium salts, magnesium salts, and/or calcium salts. These salts may be used alone or in combination of two or more. The electrolyte solution can further contain a variety of additives as necessary.

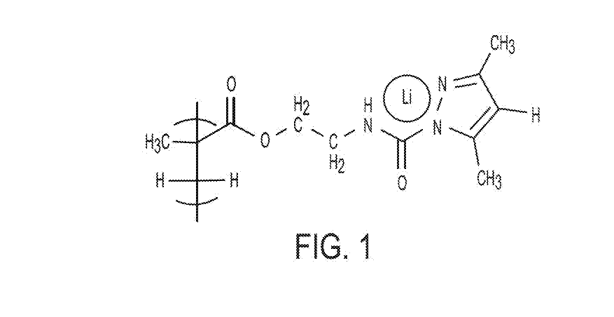

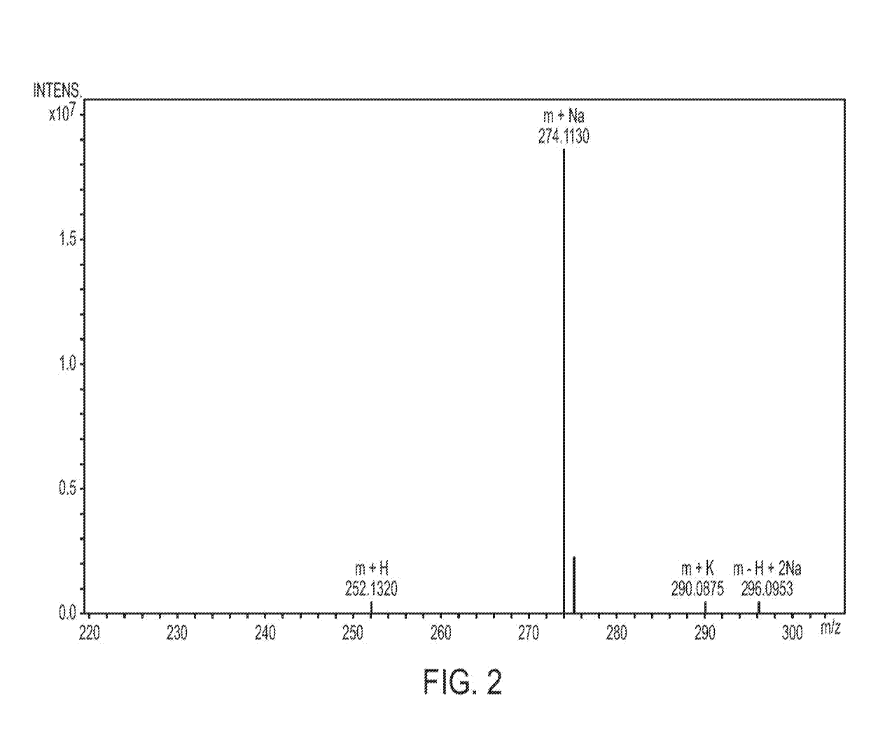

An example polymer with a pyrazole blocking group is shown in FIG. 1. The polymer, which is a polymerization product of 2-methyl-acrylic acid 2-[(3,4-dimethyl-pyrazole-1-carbonyl)-amino]-ethyl ester, may help in coordinating with metal cations present in the electrolyte. As shown in FIG. 1, without wishing to be bound by theory, the lone pair of electrons (not shown) on the nitrogen atom are able to attract the lithium ion through electrostatic interactions. Thus, the lithium ion is loosely bound to the polymer and is free to migrate during discharge or recharge. In addition to Li ions, it is believed that many oxygen and nitrogen atoms of the polymeric structure described herein may have the ability to attract other cations, such as Na-ions, K-ions, Mg-ions, Ca-ions, Fe-ions, Cu-ions, Ni-ions, Rb-ions, or any combination thereof. FIG. 2 shows a mass spectroscopic analysis of the monomer 2-methyl-acrylic acid 2-[(3,4-dimethyl-pyrazole-1-carbonyl)-amino]-ethyl ester coordinated with sodium and potassium ions. Due to the compatibility of the polymer material with the ions present in the electrolyte composition, the phase separation between the polymer and electrolyte may be limited. The lack of phase separation may lead to an absence of scattering effects and may result in a transparent gel electrolyte film. When connected to an anode or cathode, such transparent film can be part of a cell that produces electrical power. Further, the polymer structure can have a built-in mechanism to cope with runaway reactions. Such a polymer structure can have an endothermic moiety that absorbs the thermal energy if a runaway reaction takes place, thus greatly reducing the chance of explosions.

In some embodiments, a polymer with blocked isocyanate groups may serve as a binder that holds the positive electrode and negative electrode together, while also serving as the gelation material for the electrolyte. In some embodiments, the rechargeable battery may have at least one positive electrode made from a lithium compound, a sodium compound, a potassium compound, a magnesium compound, a calcium compound, a nickel compound, an iron compound, a copper compound, or any combination thereof. Non-limiting examples of a lithium compound include LiCoO₂, LiMn₂O₄, LiFePO₄, LiNiMnCoO₂, LiNiCoAlO₂, Li₄Ti₅O₁₂, Li₂(FePO₄F)₂, and any combination thereof. In some embodiments, the rechargeable battery may have at least one negative electrode made from a carbon compound, a titanate, a silicon compound, a germanium compound, or any combination thereof. Table 1 shows values of average difference in potential for various counter-ions when paired with lithium.

TABLE 1

| | Average | | Weight to |
|---|---|---|---|
| | difference in | Capacity | energy |
| Counter-ion | potential | (mA · h/g) | (kW · h/kg) |
| CoO⁻₂ | 3.7 V | 140 | 0.518 |
| Mn₂O⁻₄ | 4.0 V | 100 | 0.400 |
| NiO⁻₂ | 3.5 V | 180 | 0.630 |
| FePO⁻₄ | 3.3 V | 150 | 0.495 |
| [FePO₄F]⁻₂ | 3.6 V | 115 | 0.414 |
| [(Co_{0.33}/Ni_{0.33}/Mn_{0.33})O₂]⁻ | 3.6 V | 160 | 0.576 |
| [(Niₓ•Mn_{y}•Co_{z})O₂]⁻ | 4.2 V | 220 | 0.920 |

Table 2 represents common negative electrode materials that may be used in lithium-ion batteries.

TABLE 2

| | | | Weight to |
|---|---|---|---|
| | Average potential | Capacity | energy |
| Electrode material | difference | (mA · h/g) | (kW · h/kg) |
| Graphite | 0.1-0.2 V | 372 | 0.0372-0.0744 |
| Hard carbon | 0.1-0.2 V | 450 | 0.0372-0.0744 |
| Titanate | 1.0-2.0 V | 160 | 0.16-0.32 |
| Si | 0.5-1.0 V | 4212 | 2.106-4.212 |
| Ge | 0.7-1.2 V | 1624 | 1.137-1.949 |

In some embodiments, a gel electrolyte composition of the present disclosure may contain one or more non-aqueous solvents and/or aprotic solvents. Non-limiting examples include glycerol, sorbitol, propylene glycol, ethylene glycol, dioxane, benzonitrile, allyl methyl sulfone, diethyl carbonate, dimethyl carbonate, ethyl methyl carbonate, fluoroethylene carbonate, 3-(methylsulfonyl)-1-propyne, vinylene carbonate, and any combination thereof. In some embodiments, a gel electrolyte composition may contain water.

The polymers described herein may exhibit excellent electrolyte retaining ability, excellent ion conductivity, higher mechanical strength, and excellent shape preservation. In some embodiments, the polymer may be present in the gel electrolyte composition at a concentration of about 0.01 weight percent to about 99 weight percent. For example, the polymer may be present in the gel electrolyte composition at a concentration of about 0.01 weight percent to about 80 weight percent, about 0.01 weight percent to about 60 weight percent, about 0.01 weight percent to about 30 weight percent, or about 0.01 weight percent to about 10 weight percent. Specific examples include about 0.01 weight percent, about 10 weight percent, about 20 weight percent, about 50 weight percent, about 75 weight percent, or about 99 weight percent, and ranges between (and including the endpoints of) any two of these values.

In some embodiments, the rechargeable battery with the polymers described herein may generate a potential difference, and hence an electric current, between the positive electrode and the negative electrode. The potential difference that can be generated between the positive electrode and the negative electrode can be, for example, about 0.001 V to about 10 V. For example, the potential difference can be about 0.001 V to about 5 V, about 0.001 V to about 1 V, about 0.001 V to about 0.1 V, or about 0.001 V to about 0.01 V. Specific examples include about 0.001 V, about 0.01 V, about 0.1 V, about 1 V, about 2.5 V, about 5 V, about 10 V, and ranges between (and including the endpoints of) any two of these values. Several of these rechargeable batteries may be further connected in series or in parallel and packaged together to form a battery pack that achieves a desired overall voltage and current capacity.

In some embodiments, a method of preparing a monomer with blocked isocyanate groups may involve contacting the monomer having isocyanate functional groups with a blocking agent to form a monomer with blocked isocyanate groups. The monomer may be any of the monomers described herein. An example monomer that may be used in the preparation is 2-methyl-acrylic acid 2-isocyanato-ethyl ester. The blocking agent may be any of the blocking agents described herein. The blocking agent may be dissolved in a solvent such as chloroform. An illustrative blocking agent that may be used in the preparation may be 3,4-dimethyl-1H-pyrazole.

The monomer can be contacted with a cold solution of the blocking agent dissolved in at least one solvent, such as chloroform, for several hours with mixing. The reaction temperature may be kept low during the process, and the product can be de-colorized and purified. In some embodiments, the blocking agent and the monomer may be mixed in a molar ratio of about 1:0.5 to about 1:1.5. For example, the blocking agent and the monomer may be mixed in a molar ratio of about 1:0.5 to about 1:1.25, about 1:0.5 to about 1:1, about 1:0.5 to about 1:0.975, or about 1:0.5 to about 1:0.75. Specific examples include, for example, about 1:0.5, about 1:0.75, about 1:0.975, about 1:1, about 1:1.25, about 1:1.5 and ranges between (and including the endpoints of) any two of these values. The mixing may be performed for a period of time. For example, the mixing may be performed for about 2 hours, for about 3 hours, for about 4 hours, for about 5 hours, for about 6 hours, for about 8 hours or a range between (and including the endpoints of) any two of these values. In some embodiments, the temperature of the reaction may be below 30° C., below 28° C., below 27° C. or below 25° C. In some embodiments, the solvent may be removed from the reaction mixture after the reaction process. In some embodiments, the monomer product may be de-colorized by passing the product through a de-coloring agent such as activated carbon, alumina, sodium hypochlorite, or the like. In some embodiments, the monomer may be further purified by distillation. An example of a monomer with blocked isocyanate group is 2-methyl-acrylic acid 2-[(3,4-dimethyl-pyrazole-1-carbonyl)-amino]-ethyl ester.

In some embodiments, the gel electrolyte composition may be prepared by polymerizing the monomer having a plurality of blocked isocyanate groups. During polymerization, the monomer with blocked isocyanate groups may be dissolved in at least one solvent. Suitable solvents include glycerol, sorbitol, propylene glycol, ethylene glycol, water, dioxane, benzonitrile, allyl methyl sulfone, diethyl carbonate, dimethyl carbonate, ethyl methyl carbonate, fluoroethylene carbonate, 3-(methylsulfonyl)-1-propyne, vinylene carbonate, and any combination thereof. The solvent may further include lithium ions generated from lithium salts, such as Li₂B₄O₇, Li₂ZrO₃, Li₂TiO₃, Li₄SiO₄, LiAlO₂, LiBO₂, LiAlSi2O₆, LiPF₆, LiAsF₆, LiClO₄, LiBF₄, LiCF₃SO₃, and any combination thereof. For polymerization, suitable cross-linking agent(s) and initiator(s) may be added. Non-limiting examples of cross-linking agents include methylene(bis)acrylamide, polyethylene glycol dimethacrylate, glycerol dimethacrylate, ethylene glycol dimethacrylate, propylene glycol dimethacrylate, neopentyl glycol dimethacrylate, 1,3-butanediol dimethacrylate, bisphenol A dimethacrylate, diurethane dimethacrylate, triethylene glycol dimethacrylate, tetraethylene glycol dimethacrylate, poly(propylene glycol) dimethacrylate, bisphenol A glycerolate dimethacrylate, bisphenol A ethoxylate dimethacrylate, bis(2-methacryloyl)oxyethyl disulfide, and any combination thereof. Suitable initiators that may be used include persulfates, peroxides, thiosulfates, or any combination thereof. An example of an initiator may be lithium persulfate. In some embodiments, polymerization may also be brought about by thermal activation, photochemical activation (UV-irradiation), or activation by electron bombardment.

During polymerization, the mixture of the monomer, solvent, cross-linking agent, and the initiator may be heated to an elevated temperature. For example, heating may be performed at about 50° C. to about 90° C. For example, the mixture may be heated to a temperature of about 50° C. to about 80° C., about 50° C. to about 70° C., or about 50° C. to about 60° C. Specific examples include about 50° C., about 60° C., about 75° C., about 80° C., about 90° C., and ranges between (and including the endpoints of) any two of these values. The heating may be performed for a period of time. For example, the mixture may be heated for about 30 minutes to about 2 hours, for example, about 30 minutes to about 1 hour, or about 30 minutes to about 45 minutes. Specific examples include about 30 minutes, about 45 minutes, about 1 hour, about 1.5 hours, about 2 hours, and ranges between (and including the endpoints of) any two of these values.

The polymer gel electrolyte compositions as described herein may be employed in any rechargeable battery, and are not limited to Li-ion batteries. Suitable rechargeable batteries include Na-ion batteries, K-ion batteries, Ni—Li batteries, Ni-MH batteries, Rb-ion batteries, and Ca-ion batteries. The rechargeable batteries may be used to power any electrical or electronic device, an automobile, or an appliance. Non-limiting examples include laptops, cell phones, tablets, cars, trucks, radios, toys, power tools, bicycles, kitchen appliances, flash lights, clocks, remote control devices, and the like. The rechargeable batteries may also be used in medical implants, underwater operations, and space explorations.

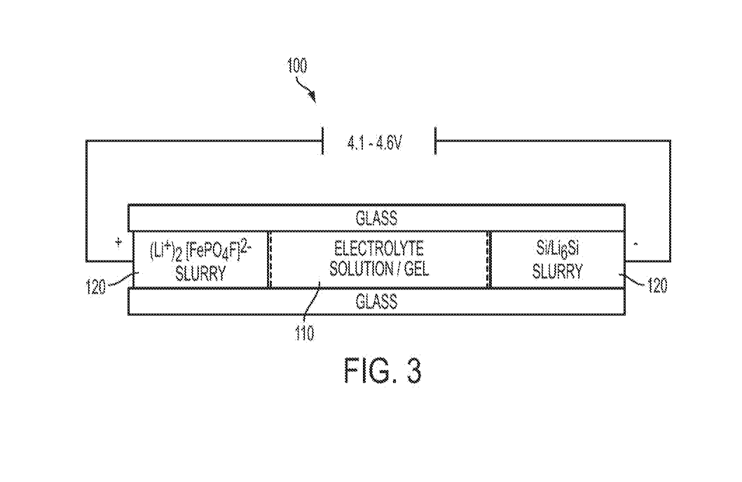

An exemplary rechargeable Li-ion battery is shown in FIG. 3. The battery 100 may include polymer gel electrolyte 110 between two electrodes 120. The polymer gel electrolyte as described herein can coordinate with lithium ions. This coordination acts to solvate the lithium ions by the polymer binder itself and create a clear, transparent gel medium. The coordination of the lithium ions can help to reduce runaway reactions and spontaneous decomposition of the battery by slowing rapid diffusion of the ions and allow for effective and efficient performance of the battery. The uniform distribution of the lithium compound in contrast to phase-separated domains may improve efficient charge-discharge cycles. Furthermore, formulations of new gel structure may have endothermic moieties and thus minimizes runaway reaction events. For example, the blocking agent may absorb the excess thermal energy from the surrounding environment and de-block or dissociate from the isocyanate groups. Further, the amount of thermal energy required to de-block may be tuned by using different moieties. However, once the runway reaction has gone its course, the blocking agent may slowly react with isocyanate groups and add back to the gel material to reform the gel material in its original state.

### EXAMPLES

### Example 1

### Preparation of a Monomer with Blocked Isocyanate Groups

A 10% (weight percent) solution of 3,5-dimethylpyrazole was prepared using a freshly distilled chloroform and a freshly distilled 3,5-dimethyl-1H-pyrazole. The solution was prepared under dry argon and was cooled to about 1-3° C. on an ice bath. A solution of 2-methyl-acrylic acid 2-isocyanotoethyl ester was added drop wise (0.05 mL/2 seconds) to the chloroform/3,5-dimethyl-1H-pyrazole solution. The molar ratio of the ester and 3,5-dimethyl-1H-pyrazole in the reaction was 0.975:1. The solution was stirred under dry argon for six hours, and the solution was slowly warmed to 20° C. The chloroform was then removed by rotary evaporation using a dry ice trap. The temperature of the bath was maintained below 27° C. during the removal of chloroform. A light yellow viscous liquid was obtained and the liquid was de-colorized by adding activated carbon and filtering it. The resulting colorless clear liquid was then distilled under vacuum (10⁻⁶ torr) to obtain 2-methyl-acrylic acid 2-[(3,4-dimethyl-pyrazole-1-carbonyl)-amino]-ethyl ester. The product was confirmed by ¹H NMR.

### Example 2

### Polymerization of the Monomer

The monomer prepared in Example 1 (0.318 moles) is dissolved in 100 mL of glycerol along with LiPF₆. About 10 grams of cross-linking agent polyethylene glycol dimethacrylate and 4.2 grams of initiator lithium persulfate are added, and the solution is heated to a temperature of about 75° C. for 45 minutes. The monomer polymerizes into a gel. The gel may be used as an electrolyte conductive medium between the electrodes.

### Example 3

### Polymerization of the Monomer

The monomer prepared in Example 1 (0.316 moles) is dissolved in 100 mL of propylene glycol along with LiPF₆. About 8.9 grams of cross-linking agent methylene(bis)-acrylamide and 4 grams of initiator lithium persulfate are added, and the solution is heated to a temperature of about 75° C. for 45 minutes. The monomer polymerizes into a gel. The gel may be used as an electrolyte conductive medium between the electrodes.

### Example 4

### Preparation of a Li-Ion Battery

The positive electrode is prepared by mixing the lithium iron phosphate Li(FePO₄) in glycerol to obtain a slurry, which serves as a positive current collector. The slurry is coated on an aluminum foil, dried, and rolled to form the positive electrode. The negative electrode is prepared by mixing lithium silicate in glycerol to obtain a slurry, which serves as a negative current collector. The slurry is coated on a copper foil, dried, and rolled to form the negative electrode.

A thin layer of the gel polymer is prepared as in Example 2, and soaked in an electrolyte solution containing LiPF₆ and glycerol. The positive and negative electrodes prepared above are contacted with the opposite surfaces of the gel polymer such that the polymer is sandwiched between the electrodes. The electrodes are connected to an electrical device to complete the circuit. The battery will provide an output of 3V to 3.3 V.

### Example 5

### Preparation of a Li-Ion Battery

The positive electrode is prepared by mixing the lithium iron phosphate Li₂(FePO₄Fe)₂ in propylene glycol to obtain a slurry, which serves as a positive current collector. The slurry is coated on an aluminum foil, dried, and rolled to form the positive electrode. The negative electrode is prepared by mixing lithium silicate in propylene glycol to obtain a slurry, which serves as a negative current collector. The slurry is coated on a copper foil, dried, and rolled to form the negative electrode. The gel polymer prepared in Example 3 is mixed with an electrolyte solution containing propylene glycol and LiPF₆, and poured into a cylindrical transparent glass tube such that the polymer gel electrolyte slurry occupies a central portion of the tube. One end of the glass tube is filled with the positive electrode slurry and the opposite end with the negative electrode slurry as prepared above. The gel electrolyte contacts the electrodes at either end and forms a bridge between them. The transparent Li-ion battery is connected to an external electrical device to complete the circuit. The battery will provide an output of 3V to 3.3 V.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and one or more to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A battery comprising:
a gel electrolyte composition comprising:
a polymer of isocyanatoethyl methacrylate having a blocking agent reacted with an isocyanate group of the isocyanatoethyl methacrylate;
at least one negative electrodes; and
at least one positive electrode,
wherein the at least one negative electrode and the at least one positive electrode are in contact with the gel electrolyte composition.

2.-3. (canceled)

4. The battery of claim 1, wherein the blocking agent is selected from the group consisting of an alcohol, an imidazole, a methyl imidazole, a pyrazole, a pyrrole, a pyrrolidine, a morpholine, a pyridine, a piperidine, an alkyl malonate ester, an acetoacetic ester, a cyanoacetic ester, an oxime and a caprolactam.

5. The battery of claim 1, wherein the blocking agent is 3,4-dimethyl-1H-pyrazole.

6. The battery of claim 1, wherein the gel electrolyte composition comprises a polymerization product of 2-methyl-acrylic acid 2-[(3,4-dimethyl-pyrazole-1-carbonyl)-amino]-ethyl ester.

7. The battery of claim 1, wherein the at least one positive electrode is selected from the group consisting of a lithium compound, a sodium compound, a potassium compound, a magnesium compound, a calcium compound, a nickel compound, an iron compound and a copper compound.

8. (canceled)

9. The battery of claim 1, wherein the at least one negative electrode is selected from the group consisting of a carbon compound, a titanate, a silicon compound and a germanium compound.

10. (canceled)

11. The battery of claim 1, wherein the gel electrolyte composition further comprises a solvent selected from the group consisting of glycerol, sorbitol, propylene glycol, ethylene glycol, water, dioxane, benzonitrile, allyl methyl sulfone, diethyl carbonate, dimethyl carbonate, ethyl methyl carbonate, fluoroethylene carbonate, 3-(methylsulfonyl)-1-propyne and vinylene carbonate.

12. The battery of claim 1, wherein the gel electrolyte composition further comprises a lithium salt selected from the group consisting of Li₂B₄O₇, Li₂ZrO₃, Li₂TiO₃, Li₄SiO₄, LiAlO₂, LiBO₂, LiAlSi2O₆, LiPF₆, LiAsF₆, LiClO₄, LiBF₄ and LiCF₃SO₃.

13. The battery of claim 1, wherein an electric current generated between the at least one positive electrode and the at least one negative electrode yields a battery voltage of about 0.001 V to about 10 V.

14. (canceled)

15. The battery of claim 1, wherein the polymer further comprises a coordinating metal ion selected from the group consisting of Li, Na, K, Mg, Ca, Fe, Cu, Ni, Rb and.

16. The battery of claim 1, wherein the battery is a Li-ion battery, a Na-ion battery, a K-ion battery, a Ni—Li battery, a Ni-MH battery, a Rb-ion battery, or a Ca-ion battery.

17. A gel electrolyte composition comprising:
a polymer of isocyanatoethyl methacrylate having a blocking agent reacted with an isocyanate group of the isocyanatoethyl methacrylate.

18. (canceled)

19. The gel electrolyte composition of claim 17, wherein the blocking agent is selected from the group consisting of an alcohol, an imidazole, a methyl imidazole, a pyrazole, a pyrrole, a pyrrolidine, a morpholine, a pyridine, a piperidine, an alkyl malonate ester, an acetoacetic ester, a cyanoacetic ester, an oxime and a caprolactam.

20. The gel electrolyte composition of claim 17, further comprising a solvent selected from the group consisting of glycerol, sorbitol, propylene glycol, ethylene glycol, water, dioxane, benzonitrile, allyl methyl sulfone, diethyl carbonate, dimethyl carbonate, ethyl methyl carbonate, fluoroethylene carbonate and 3-(methylsulfonyl)-1-propyne, vinylene carbonate.

21. The gel electrolyte composition of claim 17, further comprising a lithium salt selected from the group consisting of Li₂B₄O₇, Li₂ZrO₃, Li₂TiO₃, Li₄SiO₄, LiAlO₂, LiBO₂, LiAlSi2O₆, LiPF₆, LiAsF₆, LiClO₄, LiBF₄ and LiCF₃SO₃.

22. The gel electrolyte composition of claim 17, wherein the polymer is present in the gel electrolyte composition at a concentration of about 0.01 weight percent to about 99 weight percent.

23. The gel electrolyte composition of claim 17, wherein the polymer further comprises a coordinating metal ion selected from the group consisting of Li, Na, K, Mg, Ca, Fe, Cu, Ni and Rb.

24. A method of preparing a gel electrolyte composition, the method comprising:
contacting a monomer with a solvent, a cross-linker and an initiator to form a mixture, wherein the monomer comprises isocyanatoethyl methacrylate having a blocked isocyanate group; and
heating the mixture.

25. The method of claim 24, wherein the contacting the monomer comprises contacting 2-methyl-acrylic acid 2-[(3,4-dimethyl-pyrazole-1-carbonyl)-amino]-ethyl ester.

26. The method of claim 24, further comprising forming the monomer by reacting an unblocked isocyanatoethyl methacrylate with a blocking agent, wherein the blocking agent reacts with an isocyanate group of the isocyanatoethyl methacrylate.

27.-28. (canceled)

29. The method of claim 26, wherein the reacting comprises reacting with the blocking agent selected from the group consisting of an alcohol, an imidazole, a methyl imidazole, a pyrazole, a pyrrole, a pyrrolidine, a morpholine, a pyridine, a piperidine, an alkyl malonate ester, an acetoacetic ester, a cyanoacetic ester, an oxime and a caprolactam.

30. The method of claim 26, wherein the reacting comprises reacting with a blocking agent comprising 3,4-dimethyl-1H-pyrazole.

31. The method of claim 24, wherein the contacting comprises contacting with a solvent selected from the group consisting of glycerol, sorbitol, propylene glycol, ethylene glycol, water, dioxane, benzonitrile, allyl methyl sulfone, diethyl carbonate, dimethyl carbonate, ethyl methyl carbonate, fluoroethylene carbonate, 3-(methylsulfonyl)-1-propyne and vinylene carbonate.

32. The method of claim 24, wherein the contacting comprises contacting with a solvent further comprising a lithium salt selected from the group consisting of Li₂B₄O₇, Li₂ZrO₃, Li₂TiO₃, Li₄SiO₄, LiAlO₂, LiBO₂, LiAlSi2O₆, LiPF₆, LiAsF₆, LiClO₄, LiBF₄ and LiCF₃SO₃.

33. The method of claim 24, wherein the contacting comprises contacting with a cross-linking agent selected from the group consisting of methylene(bis)acrylamide, polyethylene glycol dimethacrylate, glycerol dimethacrylate, ethylene glycol dimethacrylate, propylene glycol dimethacrylate, neopentyl glycol dimethacrylate, 1,3-butanediol dimethacrylate, bisphenol A dimethacrylate, diurethane dimethacrylate, triethylene glycol dimethacrylate, tetraethylene glycol dimethacrylate, poly(propylene glycol) dimethacrylate, bisphenol A glycerolate dimethacrylate, bisphenol A ethoxylate dimethacrylate and bis(2-methacryloyl)oxyethyl disulfide.

34. The method of claim 24, wherein the contacting comprises contacting with an initiator selected from the group consisting of a persulfate, a peroxide and a thiosulfate.

35. The method of claim 24, wherein heating the mixture comprises heating at a temperature of about 50° C. to about 90° C. for about 30 minutes to about 2 hours.

36.-47. (canceled)
